(19) United States
(12) Patent Application Publication
(10) Pub. No.: US 2019/0068556 A1
(43) Pub. Date: Feb. 28, 2019

(54) METHOD TO AVOID INSPECTION BYPASS DUE TO DNS POISONING OR HTTP HOST HEADER SPOOFING

(71) Applicant: CHECK POINT SOFTWARE TECHNOLOGIES LTD., TEL AVIV (IL)

(72) Inventors: Amnon PERLMUTTER, Givatayim (IL); Lior DRIHEM, Givat Shmuel (IL)

(21) Appl. No.: 15/691,820

(22) Filed: Aug. 31, 2017

(51) Int. Cl. H04L 29/06

(52) U.S. Cl. CPC H04L 63/0281; H04L 63/168; H04L 63/166

(57) ABSTRACT

Cyber security protection from, and avoiding inspection bypass, in network communication connections, in particular due to DNS poisoning or HTTP HOST header spoofing includes receiving a request for a resource. Typically, the request is received by a proxy from a web browser on a client for a web page on a server. The request is communicated via transport layer security (TLS) protocol. The TLS protocol includes a server name indication (SNI) extension and the SNI extension includes a first location of the resource. A connection is initiated, by the proxy, to the first location (included in said SNI extension), ignoring a second location in the original request.

### FIELD OF THE INVENTION

The present invention generally relates to computer security, and in particular, it concerns protection from inspection bypass.

### BACKGROUND OF THE INVENTION

DNS (Domain Name System) spoofing, also referred to as DNS cache poisoning, is a form of computer security hacking in which corrupt DNS data is introduced into the DNS resolver's cache, causing the name server to return an incorrect IP (Internet Protocol) address.

Inspection of HTTP/S traffic by security gateways can be tricked by spoofing the HTTP HOST header or by DNS poisoning.

Information on the HTTP can be found in the IETF (Internet Engineering Task Force) RFC (Request for Comments) 2616, available for example at https://www.ietf.org/rfc/rfc2616.txt.

Information on the Transport Layer Security (TLS) Protocol can be found in the IETF RFC 5246, available for example at https://tools.ietf.org/html/rfc5246.

Information on TLS Extensions can be found in the IETF RFC 6066, available for example at https://tools.ietf.org/html/rfc6066.

### SUMMARY

According to the teachings of the present embodiment there is provided a method for cyber security of network connections, including the steps of: receiving a request for a resource, the request communicated via transport layer security (TLS) protocol, the TLS protocol including server name indication (SNI) extension, and he SNI extension including a first location of the resource; and initiating a connection to the first location included in the SNI extension.

In an optional embodiment, the request includes a second location of the resource, and the initiating ignores the second location.

In another optional embodiment, the first location is selected from the group consisting of: the second location; other than the second location; and different location from the second location, and a hostname of a server on a network.

In another optional embodiment, the second location is selected from the group consisting of: an internet host in a host header field of an HTTP request message; and derived from a Uniform Resource Locator (URL) supplied by a user on a client.

In another optional embodiment, the request is received by a transparent proxy from a web browser on a client for a resource on a server. In another optional embodiment, the request is a Hypertext Transfer Protocol (HTTP) request message. In another optional embodiment, the resource is a web page.

According to the teachings of the present embodiment there is provided a system including: a processing system containing one or more processors, the processing system being configured to: receive a request for a resource, the request communicated via transport layer security (TLS) protocol, the TLS protocol including server name indication (SNI) extension, and the SNI extension including a first location of the resource; and initiate a connection to the first location included in the SNI extension.

In an optional embodiment, the request includes a second location of the resource, and the initiating ignores the second location.

In another optional embodiment, the first location is selected from the group consisting of: the second location; other than the second location; a different location from the second location, and a hostname of a server on a network, and the second location is selected from the group consisting of: an internet host in a host header field of an HTTP request message; and derived from a Uniform Resource Locator (URL) supplied by a user on a client.

In another optional embodiment, the processing system is a transparent proxy, and the request is received from a web browser on a client, the request including a resource on a server. In another optional embodiment, the request is a Hypertext Transfer Protocol (HTTP) request message. In another optional embodiment, the resource is a web page.

According to the teachings of the present embodiment there is provided a non-transitory computer-readable storage medium having embedded thereon computer-readable code for cyber security of network connections, the computer-readable code including program code for: receiving a request for a resource, the request communicated via transport layer security (TLS) protocol, the TLS protocol including server name indication (SNI) extension, and the SNI extension including a first location of the resource; and initiating a connection to the first location included in the SNI extension.

According to the teachings of the present embodiment there is provided a computer program that can be loaded onto a server connected through a network to a client computer, so that the server running the computer program constitutes a transparent proxy in a system according to the current description.

According to the teachings of the present embodiment there is provided a computer program that can be loaded onto a computer connected through a network to a server, so that the computer running the computer program constitutes a client computer in a system according to the current description.

### BRIEF DESCRIPTION OF FIGURES

The embodiment is herein described, by way of example only, with reference to the accompanying drawings, wherein:

FIG. 1 is a diagram of a typical, conventional network configuration.

FIG. 2 is a diagram of a system for protecting and avoiding inspection bypass in network communication.

FIG. 3 is a high-level partial block diagram of an exemplary system configured to implement the proxy of the present invention.

### ABBREVIATIONS AND DEFINITIONS

For convenience of reference, this section contains a brief list of abbreviations, acronyms, and short definitions used in this document. This section should not be considered limiting. Fuller descriptions can be found below, and in the applicable Standards.

DNS—Doman Name Server

HTTP—Hypertext Transfer Protocol

IETF—Internet Engineering Task Force.

IP—Internet Protocol.

RFC—Request for Comments.

SNI—Server Name Indication.

SSL—Secure Socket Layer.

TCP—Transmission Control Protocol.

TLS—Transport Layer Security.

Transparent proxy—also known as an intercepting proxy, inline proxy, or forced proxy.

URI—Uniform Resource Identifier.

URL—Uniform Resource Locator.

URN—Uniform Resource Name.

VPN—Virtual Private Network.

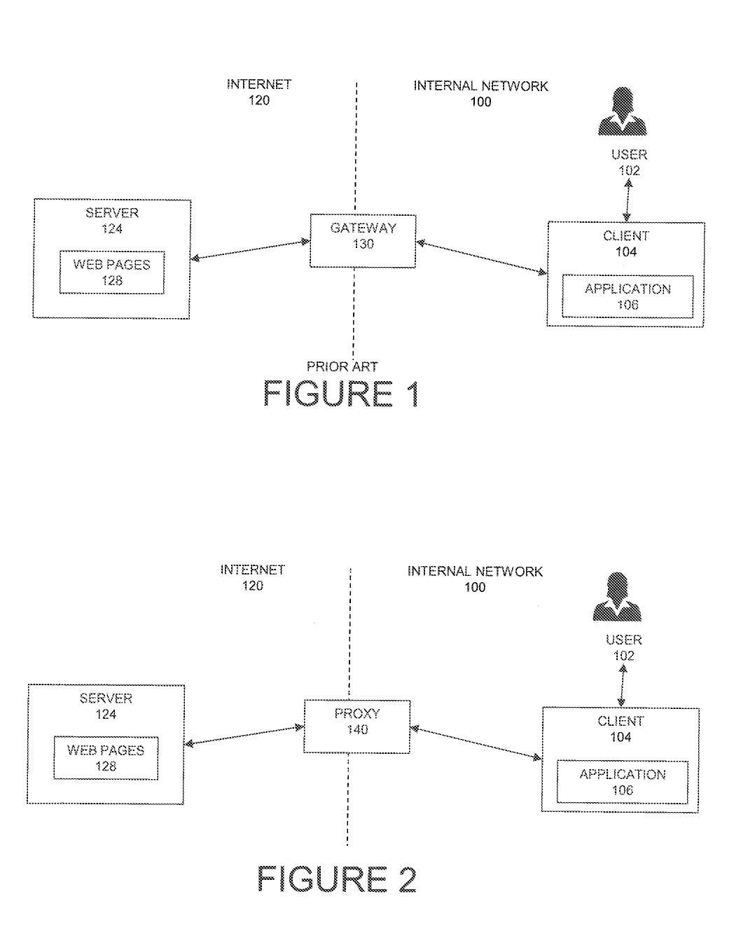

### DETAILED DESCRIPTION—FIRST EMBODIMENT—FIGS. 1 TO 3

The principles and operation of the system and method according to a present embodiment may be better understood with reference to the drawings and the accompanying description. A present invention facilitates cyber security protection from, and avoiding inspection bypass, in network communication connections, in particular due to DNS poisoning or HTTP HOST header spoofing.

In general, a request is received for a resource. The request is communicated via transport layer security (TLS) protocol. The TLS protocol includes a server name indication (SNI) extension, and the SNI extension includes a first location of the resource. A connection is initiated to the first location included in the SNI extension. A feature of this embodiment is that the request normally includes a second location of the resource, and conventional techniques exclusively use the second location for initiating a connection to the resource, in contrast to the current embodiment in which the initiating ignores the second location.

Referring now to the drawings, FIG. 1 is a diagram of a typical, conventional network configuration. An external network, such as internet 120 is connected via a gateway 130 to an internal network 100. On the internet 120 is deployed a server 124, typically a web server having one or more web pages 128. On the internal network 100 is deployed a client 104 used by a user 102.

The internet 120 can be any network separate from the internal network 100, including but not limited to the Internet, sub-networks, networks other than the internal network 100, a network other than the network on which the client 104 is deployed, or even another machine on the internal network other than the client machine.

The server 124 may be one or more devices including one or more processors in one or more locations, implemented physically or virtually, as is know in the current state of the art. In this description, the server may be referred to as a web server, host, and Internet host. The server 124 can provide (serve) one or more websites, host one or more virtual servers, and in general provide resource(s) including service(s) to client(s) 104.

For simplicity, the gateway 130 is used to represent a variety of devices, one or more of which can be deployed between the internet 120 and internal network 100, in particular between the server 124 and the client 104. In the context of this description, the gateway 130 can represent devices including, but not limited to routers, proxies, proxy servers, servers, firewalls, etc., in general a computing device configured for implementing the appropriate modules of the current embodiment. Alternatively, the gateway 130 can be implemented as a module on the client 104 or in another location on the internet 120 or internal network 100, as is known in the art.

Internal network 100 represents a location on which the users 102 work, on which the users' corresponding machines (client 104) are deployed. Generally, the internal network 100 is an organization's IT infrastructure, and is referred to in the context of this description as the “organization's network” or “network at the organization”. One skilled in the art will realize that for simplicity, the term “internal network” can include a variety of physical implementation and architectures, including but not limited to one or more subnets and additional networks co-located or in physically diverse locations.

The client 104 is generally a computing device running one or more applications such as the exemplary application 106. For simplicity in this description, the exemplary application 106 is generally a web browser (or simply “browser). Other applications include, but are not limited to email, and SMS. The client is generally a user's computing device, and is sometimes referred to in specifications (such as RFC 2616) as an “origin server” (not to be confused with the server 124 of the current description). The user 102 can use an application 106 to access a resource, or the application 106 can be a process that accesses resources.

As is known in the art, computing devices such as client 104 can be elements such as desktop computers, consoles, laptops, and cell phones referred to as computers, computing devices, and machines.

References to the (single) user 102 may also be in the plural “users”, as appropriate for clarity of the discussion, as will be obvious to one skilled in the art. Users may also be referred to in the context of this description as victims or targets. Similarly, references to the (plural) web pages 128 may also be in the singular “webpage” as appropriate for clarity and simplicity.

Refer now to FIG. 2, a diagram of a system for protecting and avoiding inspection bypass in network communication. The gateway 130 is augmented and/or replaced with a proxy 140. The proxy 140 is typically a transparent proxy. Alternatively, the proxy 140 can be a security gateway. A transparent proxy is also known as an intercepting proxy, inline proxy, or forced proxy. Transparent proxies are intermediary systems that sit between a user and a content provider (between the client 104 and the server 124). When a user makes a request to a web server, the transparent proxy intercepts the request to perform various actions including caching, redirection, and authentication. A transparent proxy intercepts normal communication at the network layer without requiring any special client configuration. Clients need not be aware of the existence of the proxy. A transparent proxy is normally located between the client and the Internet, with the proxy optionally performing some of the functions of a gateway or router.

RFC 2616 (HTTP) defines a ‘transparent proxy’ as a proxy that does not modify the request or response beyond what is required for proxy authentication and identification. A ‘non-transparent proxy’ is a proxy that modifies the request or response in order to provide some added service to the user agent, such as group annotation services, media type transformation, protocol reduction, or anonymity filtering.

When the user 102 or the application 106 wants access to a resource, the client can be used to access via the proxy 140 a resource on the server 124. For simplicity in the current description, the non-limiting example of the client 104 requesting a webpage 128 will be used. Based on this description, one skilled in the art will be able to implement implementations for various users, applications, and clients to a variety of resources.

The client 104 generates a request for a resource, the request including a locator or indicator for the resource. The request is sent from the client 104 to the server 124 via the proxy 124. Thus, the client 104 sends the request to the proxy 140 and the proxy 140 receives the request from the client 104. In the current example, the application 106 on the client 104 is a web browser that generates an HTTP request message for a resource that is a web page 128. The request includes a “Host header field” that includes the internet host and typically also the port number of the resource being requested. The host header field information is typically obtained from (based on) the original URI or HTTP URL given by the user 102 or the application 106. The Host header field value must represent the naming authority of the client or gateway given by the original URL. This allows the client or gateway to differentiate between internally ambiguous URLs, such as the root “/” URL of a server for multiple host names on a single IP address (multiple virtual servers on a single server 124).

In the context of this document, in the request, the location of the resource is referred to as a “second location”. The second location is typically an internet host in a host header field of an HTTP request message, typically derived from a Uniform Resource Locator (URL) supplied by a user on a client. The term “second location” is used to differentiate the location in the request from the location in the SNI extension to the TLS protocol (described further, below). In the context of this document, in the SNI extension, the location of the resource is referred to as a “first location”.

In normal network communications, the second location and first location are the same location, typically the hostname of a server on a network. In conventional implementations, the gateway 130 (acting as a security gateway) usually makes access decisions based on the Host header field. However, a conventional gateway 130 can be DNS-spoofed, also referred to as DNS cache poisoning or DNS bypass, a form of computer security hacking in which corrupt DNS data is introduced into the DNS resolver's cache, causing the name server to return an incorrect IP (Internet Protocol) address. Inspection of HTTP/S traffic by security gateways can be tricked by spoofing the HTTP Host header or by DNS poisoning. In the case of this DNS poisoning, the first location is other than the second location, a different location from the second location.

Transport Layer Security (TLS) is a protocol that provides communication security between client/server applications that communicate with each other over a network, for example, the Internet. TLS enables privacy, integrity, and protection for the data that is transmitted between different nodes on the network. TLS is a successor to the secure socket layer (SSL) protocol. The TLS protocol consists of two different layers of sub-protocols:
TLS Handshake Protocol: Enables the client and server to authenticate each other and select an encryption algorithm prior to sending the data
TLS Record Protocol: Works on top of the standard TCP protocol to ensure that the created connection is secure and reliable. Also provides data encapsulation and data encryption services.

TLS does not provide a mechanism for a client to tell a server the name of the server to which the client is contacting. Clients may desire to provide a server name to facilitate secure connections to one of multiple servers (actually virtual-servers) at a single underlying (server) network address. In order to provide any of the virtual server names, clients may include an extension of type “server name” in the (extended) client hello (ClientHello message type). SNI is an extension to the TLS computer networking security protocol. A feature of SNI is that the client 104 indicates which hostname the client 104 is attempting to connect to at the start of the handshaking process. This allows a single server (such as server 124) to present multiple security certificates on the same IP address (server 124) and TCP port number, and hence allows multiple secure (HTTPS) websites (or any other service over TLS) to be served by the same IP address without requiring all of the multiple websites to use the same security certificate. Thus, the purpose of SNI is to allow differentiation of multiple websites on the same server 124.

In contrast to the conventional use of SNI, an innovative feature of the current embodiment is to use the location (hostname) in the SNI extension to determine to which server to connect. Using the SNI extension (hostname in the SNI extension) avoids the DNS bypass and secures against DNS-spoofing/DNS cache poisoning by ignoring the second location in the original HTTP request and instead connecting based on the first location in the SNI extension. In other words, the proxy 140 (acting as a security gateway/transparent proxy) opens a connection to the host indicated in the SNI extension instead of the destination IP mentioned in the connection (HTTP request). The connection is initiated from the proxy 140 to the server 124 and the server 124 receives the connection from the proxy 140.

In general, a method for cyber security of network connections includes receiving a request for a resource. Typically, the request is received by the proxy 140 from a web browser (application 106) on the client 104 for a resource (web pages 128) on the server 124. The request is communicated via transport layer security (TLS) protocol. As described above, the TLS protocol includes a server name indication (SNI) extension and the SNI extension includes a first location of the resource. A connection is initiated, by the proxy 140, to the first location (included in the SNI extension).

The request typically includes a second location of the resource. Initiating the connection from the client 104 to the server 124 ignores the second location. The second location is excluded as a basis for initiating the connection, and only the first location is used to initiate the connection.

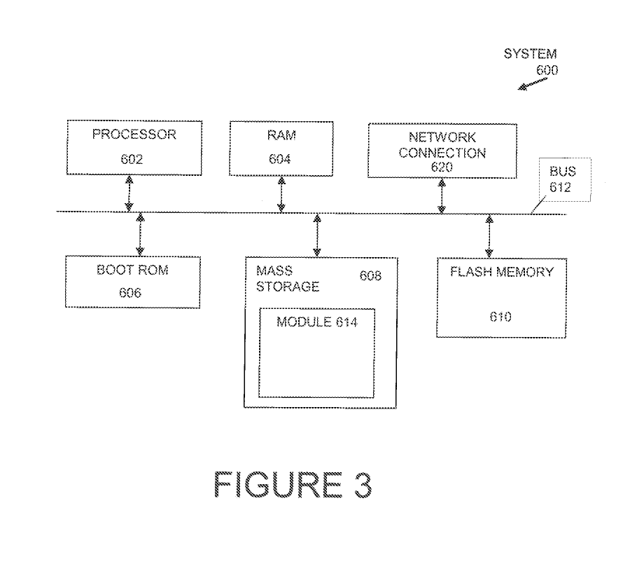

FIG. 3 is a high-level partial block diagram of an exemplary system 600 configured to implement the proxy 140 of the present invention. System (processing system) 600 includes a processor 602 (one or more) and four exemplary memory devices: a RAM 604, a boot ROM 606, a mass storage device (hard disk) 608, and a flash memory 610, all communicating via a common bus 612. As is known in the art, processing and memory can include any computer readable medium storing software and/or firmware and/or any hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used in processor 602 including but not limited to reduced instruction set computer (RISC) architecture and/or complex instruction set computer (CISC) architecture. A module (processing module) 614 is shown on mass storage 608, but as will be obvious to one skilled in the art, could be located on any of the memory devices.

Mass storage device 608 is a non-limiting example of a non-transitory computer-readable storage medium bearing computer-readable code for implementing the cyber security methodology described herein. Other examples of such computer-readable storage media include read-only memories such as CDs bearing such code.

System 600 may have an operating system stored on the memory devices, the ROM may include boot code for the system, and the processor may be configured for executing the boot code to load the operating system to RAM 604, executing the operating system to copy computer-readable code to RAM 604 and execute the code.

Network connection 620 provides communications to and from system 600. Typically, a single network connection provides one or more links, including virtual connections, to other devices on local and/or remote networks. Alternatively, system 600 can include more than one network connection (not shown), each network connection providing one or more links to other devices and/or networks.

System 600 can be implemented as a server or client respectively connected through a network to a client or server.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

Note that the above-described examples, numbers used, and exemplary calculations are to assist in the description of this embodiment. Inadvertent typographical errors, mathematical errors, and/or the use of simplified calculations do not detract from the utility and basic advantages of the invention.

To the extent that the appended claims have been drafted without multiple dependencies, this has been done only to accommodate formal requirements in jurisdictions that do not allow such multiple dependencies. Note that all possible combinations of features that would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1. A method for cyber security of network connections, comprising the steps of:
(a) receiving a request for a resource,
said request communicated via transport layer security (TLS) protocol,
said TLS protocol including server name indication (SNI) extension, and
said SNI extension including a first location of the resource; and
(b) initiating a connection to said first location included in said SNI extension.

2. The method of claim 1 wherein said request includes a second location of the resource, and said initiating ignores said second location.

3. The method of claim 2 wherein said first location is selected from the group consisting of:
(a) said second location;
(b) other than said second location; and
(c) a different location from said second location, and
(d) a hostname of a server on a network.

4. The method of claim 2 wherein said second location is selected from the group consisting of:
(a) an internet host in a host header field of an HTTP request message; and
(b) derived from a Uniform Resource Locator (URL) supplied by a user on a client.

5. The method of claim 1 wherein said request is received by a transparent proxy from a web browser on a client for a resource on a server.

6. The method of claim 1 wherein said request is a Hypertext Transfer Protocol (HTTP) request message.

7. The method of claim 1 wherein said resource is a web page.

8. A system comprising:
(a) a processing system containing one or more processors, said processing system being configured to:
(i) receive a request for a resource,
(A) said request communicated via transport layer security (TLS) protocol,
(B) said TLS protocol including server name indication (SNI) extension, and
(C) said SNI extension including a first location of the resource; and
(ii) initiate a connection to said first location included in said SNI extension.

9. The system of claim 8 wherein said request includes a second location of the resource, and said initiating ignores said second location.

10. The system of claim 8 wherein said first location is selected from the group consisting of:
(a) said second location;
(b) other than said second location;
(c) a different location from said second location, and
(d) a hostname of a server on a network,
and said second location is selected from the group consisting of:
(a) an internet host in a host header field of an HTTP request message; and
(b) derived from a Uniform Resource Locator (URL) supplied by a user on a client.

11. The system of claim 8 wherein said processing system is a transparent proxy, and said request is received from a web browser on a client, said request including a resource on a server.

12. The system of claim 8 wherein said request is a Hypertext Transfer Protocol (HTTP) request message.

13. The system of claim 8 wherein said resource is a web page.

14. A non-transitory computer-readable storage medium having embedded thereon computer-readable code for cyber security of network connections, the computer-readable code comprising program code for:
(a) receiving a request for a resource,
(i) said request communicated via transport layer security (TLS) protocol,
(ii) said TLS protocol including server name indication (SNI) extension, and
(iii) said SNI extension including a first location of the resource; and
(b) initiating a connection to said first location included in said SNI extension.
